(19) United States
(12) Patent Application Publication
(10) Pub. No.: US 2024/0218917 A1
(43) Pub. Date: Jul. 4, 2024

(54) ROTARY MOTION SYSTEM AND APPLICATION THEREOF

(71) Applicant: SHANGHAI LINGZHUAN TECHNOLOGY CO., LTD., Shanghai (CN)

(72) Inventor: Meimei DENG, Shanghai (CN)

(21) Appl. No.: 18/606,522

(22) Filed: Mar. 15, 2024

Related U.S. Application Data
(63) Continuation of application No. PCT/CN2022/082279, filed on Mar. 22, 2022.

(30) Foreign Application Priority Data
Sep. 15, 2021 (CN) 202111083127.0

(51) Int. Cl. F16H 19/08

(52) U.S. Cl. CPC F16H 19/08

(57) ABSTRACT

A rotary motion system is provided. The rotary motion system comprises an angle rotation joint having a single degree of freedom. The angle rotation joint is composed of four members which are stacked on each other. A first member is used as a basis and does not rotate, a second member is located on the first member and rotates around a first rotation axis, a third member is located at a top of the second member, and a fourth member is located at a top of the third member. The second member and the third member have a same included angle at both ends, and the fourth member is limited not to rotate along with the third member. An additional motor is provided on the first member and/or the fourth member.

### CROSS-REFERENCE TO RELATED APPLICATIONS

This patent application is a continuation of International Application No. PCT/CN2022/082279, filed on Mar. 22, 2022, which claims priority to Chinese Patent Application No. 202111083127.0, filed on Sep. 15, 2021, the entire disclosures of which are hereby incorporated by reference in their entireties.

### TECHNICAL FIELD

The present disclosure relates to the field of motion systems, in particular to a motion system for changing a platform and/or the angle of a load supported by the platform in these applications where space is limited and equipment cost needs to be considered.

### BACKGROUND

In the three-dimensional space, a freely moving object, such as an airplane, has six degrees of freedom (DoF): as shown in FIG. 1, translational degrees of freedom in 3 directions (x, y and z) and rotational degrees of freedom in 3 directions (xx, yy and zz). The motion system described in the present disclosure refers to a mechanical system designed to rotate an object in a three-dimensional space.

Traditionally, a motion system having a single degree of freedom (1DoF) as shown in FIG. 2 is mainly composed of a motor 2 and a gear box 3. The gear box 3 is provided with an output shaft for providing torque on a rotation axis of a platform 9B (hereinafter referred to as a platform rotation axis 1). Generally, as shown in FIG. 3, when greater torque is required for the platform 9B, an apparatus capable of providing linear motion, such as, but not limited to an actuator 5, may be used on a lever mechanism. The linear motion operates at a certain distance from a pivot point 4 concentric with the platform rotation axis 1. However, these motion systems require sufficient free space under the platform, but such space is difficult to meet in some cases, such as when the size of the apparatus needs to be limited. In addition, the system (such as the actuator) that provides linear motion, especially a linear motion system specially designed to ensure high reliability under extreme conditions, is expensive.

Shigeo Hirose et al. discussed an angle rotation joint in a paper at the Institute of Surveying and Automatic Control Engineering in Japan in September 1981, Vol. 17, P686 to P692. The U.S. Pat. No. 4,683,406 published in July 1987 discloses a joint assembly that can move like a human arm, which covers various design changes of angle rotation joints. The common point is that the joint is equipped with two motors to drive two members in sliding contact through inclined planes, respectively. On the other hand, neither of the aforementioned two schemes can limit the direction of the platform rotation axis 1. The United States patent US2002/0166403A1 discloses a directionally retaining angle rotation joint. Similarly, the scheme provides a driving system for two members in sliding contact through inclined planes. The Patent WO2013/080197A is also equipped with two motors to independently drive two members in sliding contact through inclined planes. The common point of the aforementioned four schemes introduced in the prior art is that two members in sliding contact through inclined planes are driven by dual motors, respectively, and the motion with two degrees of freedom is performed. And the four schemes introduced in the prior art all use snake-like robots as application scenarios. However, the scheme described in the present disclosure cannot be applied to snake-like robots, but can be used for motion systems, such as a motion and virtual reality seat, a solar tracker of a solar panel and other industrial applications.

### SUMMARY

Different from the prior art, the present disclosure provides a single-degree-of-freedom (1DoF) motion system, which refers to a mechanism for rotating a platform around a platform rotation axis 1. The present disclosure also provides a multi-degree-of-freedom motion system obtained based on the improvement of the single-degree-of-freedom motion system. The platform in the present disclosure is used for supporting the weight of a person or an object, but it should be understood that such a platform does not have to be a flat surface, and may also be a spherical surface or an irregular surface.

The single-degree-of-freedom motion system in the present disclosure is realized based on an angle rotation joint. The angle rotation joint is composed of four members, which includes a first member 6, a second member 7, a third member 8 and a fourth member 9.

The first member 6 does not rotate and is located at the lowest part as a basis of the angle rotation joint.

The second member 7 is located at the top of the first member 6 and freely rotatable around a first rotation axis 23 perpendicular to the first member 6. The second member 7 is provided with two non-parallel ends (an upper end and a lower end of the second member are not parallel), and an included angle of α is formed between two characteristic surfaces corresponding to the two ends. The characteristic surface here refers to the plane where the contact surface or the edge of the contact surface between the member and the adjacent member is located. For example, when the first member 6 has a planar upper surface, the contact surface between the second member 7 and the first member 6 is a planar ring or a planar circle. At this time, the plane where the contact surface is located is a lower characteristic surface of the second member 7. When the upper surface of the first member 6 is not a plane, such as a spherical surface, the contact surface between the second member 7 and the first member 6 is a spherical ring or a spherical surface limited by the spherical surface. At this time, the plane where the lower edge of the spherical ring or the spherical surface is located is the lower characteristic surface of the second member 7. The characteristic surfaces of other members can be determined by using similar methods.

The third member 8 is located at the top of the second member 7 and is freely rotatable around a second rotation axis 24 vertical to an inclined end (generally the top end) of the second member 7. The third member 8 is also provided with two non-parallel ends and, and is the same as the second member 7, the included angle between the characteristic surfaces corresponding to an upper end and a lower end of the third member 8 is also a.

Preferably, the rotation axis of the third member 8 (referring to the aforementioned second rotation axis 24) and the rotation axis of the second member 7 (referring to the aforementioned first rotation axis 23) are intersected on an inclined plane where the two members are in contact with each other.

The fourth member 9 is located at the top of the third member 8 and rotates around the third rotation axis 25 relative to the third member 8, and the third rotation axis 25 is vertical to the upper end of the third member 8. The fourth member 9 is used as a platform for supporting the weight of a person or an object in the scheme of the present disclosure, and definitely can also be used as a transition part for fixing and supporting the platform 9B.

Sliding contact is adopted between the four members above, and then free relative rotation is allowed between two adjacent members. The sliding contact can be performed by means of bearings 7a, 8a and 9a as shown in FIG. 5B. Of course, other sliding contact modes well known in the art can be adopted.

Without limitation, both the second member 7 and the third member 8 can rotate independently and freely, resulting in that the platform limited by the fourth member 9 performs multi-degree-of-freedom (more than one degree of freedom) motion, that is, the position or direction of the platform rotation axis 1 will also change while the platform rotates around the platform rotation axis 1.

It should be noted that, in the single-degree-of-freedom motion described in the present disclosure, the position and direction of the platform rotation axis 1 are fixed.

Only when the second member 7 and third member 8 rotate respectively in directions opposite to each other at an equal angular velocity, and only when the first member 6 and the fourth member 9 do not rotate, the platform limited by the fourth member 9 can perform single-degree-of-freedom motion around the fixed platform rotation axis 1.

Sliding contact has been adopted between the respective members. When frictional resistance still exists due to the sliding contact, since the fourth member 9 is located at the top of the rotated third member 8, it is necessary to limit the fourth member 9 to prevent the fourth member 9 from being driven by the rotated third member 8 to rotate. This limitation can be achieved by connecting the first member 6 and the fourth member 9 with a flexible joint 26 as shown in FIG. 6D. The flexible joint 26 is provided with only one rotation axis. During connection, the rotation axis of the flexible joint 26 should be arranged to be parallel to the platform rotation axis 1, so that the platform rotation axis 1 is limited by the first member 6. As mentioned above, the first member 6 does not rotate as a basis of the angle rotation joint. Therefore, the platform rotation axis 1 around which the fourth member 9 rotates is also limited without changing the direction or position after the two members are connected by the flexible joint 26.

Coordinated rotation of the second, third and fourth members may be driven by a motor managed by a control system. For example, a motor is separately arranged on each member for driving the member. For example, in the scheme described in the background art, although the rotary speed and rotary direction of the two motors can also be controlled by control management systems to achieve reverse rotation of the second member 7 and the third member 8 at an equal angular velocity. However, it is necessary to reserve sufficient installation space under the platform and adopt precise motors and control systems to realize single-degree-of-freedom motion with driving of dual motors, which cannot be satisfied in many cases and will lead to economic infeasibility.

In the scheme of the present disclosure, the coordinated rotation between the second member 7 and the third member 8 is driven by only one motor, so that the requirement for installation space may be reduced, and the system cost is greatly reduced.

In order to achieve the purpose of using only one motor to drive the second member 7 and the third member 8 to rotate respectively in directions opposite to each other at an equal angular velocity, the angle rotation joint in the present disclosure also includes a transmission assembly 11 engaged with the motor. The transmission assembly 11 is used for distributing the power of the motor to drive the second member 7 and the third member 8, respectively.

The motor and the transmission assembly 11 may be placed inside the angle rotation joint. Or, when the motor and the transmission assembly 11 are not allowed to be placed in the space inside the angle rotation joint, the motor and the transmission assembly 11 may also be placed outside the angle rotation joint. The system is also provided with a motor anti-rotation apparatus 10a (FIG. 4) for preventing the integral rotation of the motor positioned outside the angle rotation joint.

Additional members 12 and 13 driven by additional motors 16, 17 and additional transmission assemblies 14, 15 are added below and above the angle rotation joint in the present disclosure, or, a plurality of the angle rotation joints may be stacked on each other, so that one degree of freedom may be expanded to two or three or more degrees of freedom (FIG. 4, FIG. 7, FIG. 18, FIG. 19).

Exoskeletons are added around the angle rotation joint to distribute the load of the platform and protect the motor and transmission assembly 11. For example, the damage of water, dust, sharp objects to the motor and the transmission assembly 11 is prevented.

The following describes the aforementioned schemes in more detail in the forms of specific embodiments.

### BRIEF DESCRIPTION OF THE DRAWINGS

FIG. 1 is a schematic diagram of six degrees of freedom of a free object in space.

FIG. 2 is a single-degree-of-freedom motion system in the prior art.

FIG. 3 is a single-degree-of-freedom motion system using a linear motion apparatus.

FIG. 4 is an angle rotation joint with an additional motor and an additional transmission assembly.

FIG. 5A is an external schematic diagram of a single-degree-of-freedom angle rotation joint.

FIG. 5B is a section view of the angle rotation joint in FIG. 5A.

FIG. 6A is a section view of a single-degree-of-freedom angle rotation joint internally provided with a single motor.

FIG. 6B is a schematic diagram of a meshing relationship between a driving wheel set and a driving ring set in FIG. 6A.

FIG. 6C is a schematic diagram of mean radii of a driving wheel and a driving ring.

FIG. 6D is a schematic diagram of a flexible joint.

FIG. 7 is a two-degree-of-freedom angle rotation joint additionally provided with a bottom motor.

FIG. 8 is a three-degree-of-freedom angle rotation joint additionally provided with a top motor and a bottom motor.

FIG. 9A is a section view of a single-degree-of-freedom angle rotation joint externally provided with a single motor and engaged with an outer driving ring.

FIG. 9B is a schematic diagram of an outer driving ring which is a ¼ circular ring or a complete circular ring.

FIG. 9C is a schematic diagram of an external installation of an outer motor.

FIG. 10 is a schematic diagram of a spherical surface that a mounting point A follows.

FIG. 11 is a schematic diagram of a guide mechanism.

FIG. 12A is a schematic diagram of a four-bar mechanism.

FIG. 12B is an arrangement example of the four-bar mechanism in FIG. 12A.

FIG. 13A is a first meshing state of a restraint gear ring and a fixed gear ring.

FIG. 13B is a second meshing state of the restraint gear ring and the fixed gear ring.

FIG. 13C is a third meshing state of the restraint gear ring and the fixed gear ring.

FIG. 14 is a schematic diagram of a driving structure using a belt pulley or a chain wheel.

FIG. 15 is a schematic diagram of an angle rotation joint internally provided with a sliding motor.

FIG. 16 is a schematic diagram of an internally installed sliding motor limited by a bearing set.

FIG. 17 is a schematic diagram observed from a left perspective in FIG. 16.

FIG. 18 is a schematic diagram of a pitching plane.

FIG. 19A is a schematic diagram of a first arrangement form of the flexible joint.

FIG. 19B is a schematic diagram of a second arrangement form of the flexible joint.

FIG. 19C is a schematic diagram of a third arrangement form of the flexible joint.

FIG. 20 is a two-degree-of-freedom motion system additionally provided with a second bottom motor.

FIG. 21 is a three-degree-of-freedom motion system additionally provided with the second bottom motor and a second top motor.

FIG. 22 is a schematic diagram of installation of exoskeletons.

FIG. 23 is a schematic diagram of a universal joint or a spring coupling.

FIG. 24 is a schematic diagram of a mounting base.

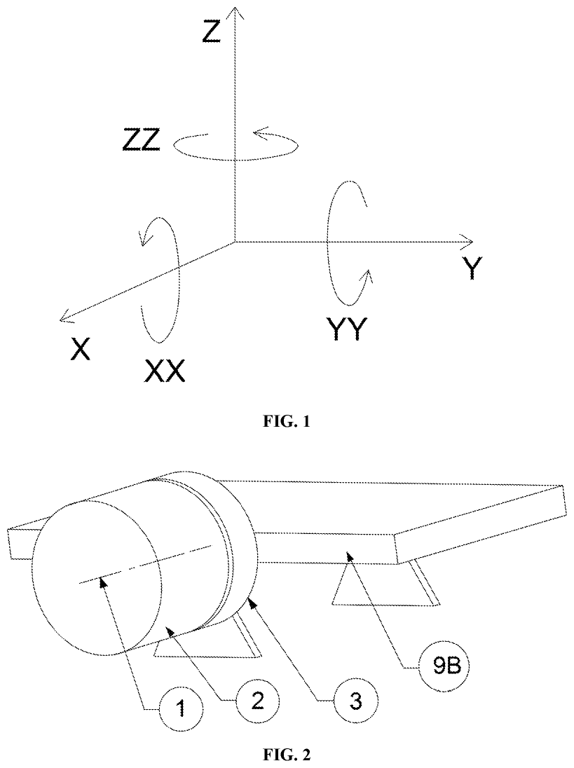

### DETAILED DESCRIPTION

### Embodiment 1

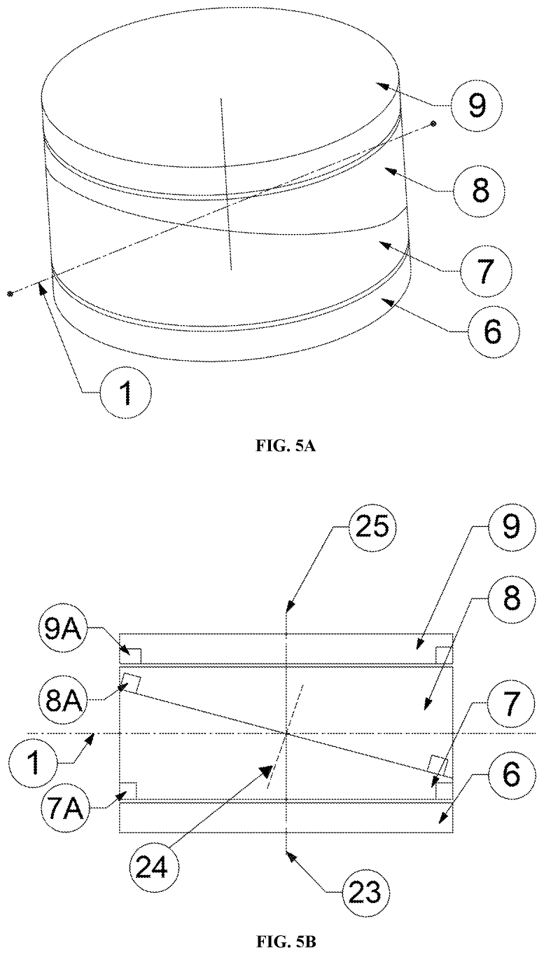

The embodiment provides an angle rotation joint, and the angle rotation joint has a single motion degree of freedom. As shown in FIG. 5A and FIG. 5B, the angle rotation joint includes four members which are stacked on each other, namely a first member 6, a second member 7, a third member 8 and a fourth member 9. The structures of the four members and surrounded rotation axis have been explained in the aforementioned parts of the summary, and are not changed or alternated in the embodiment.

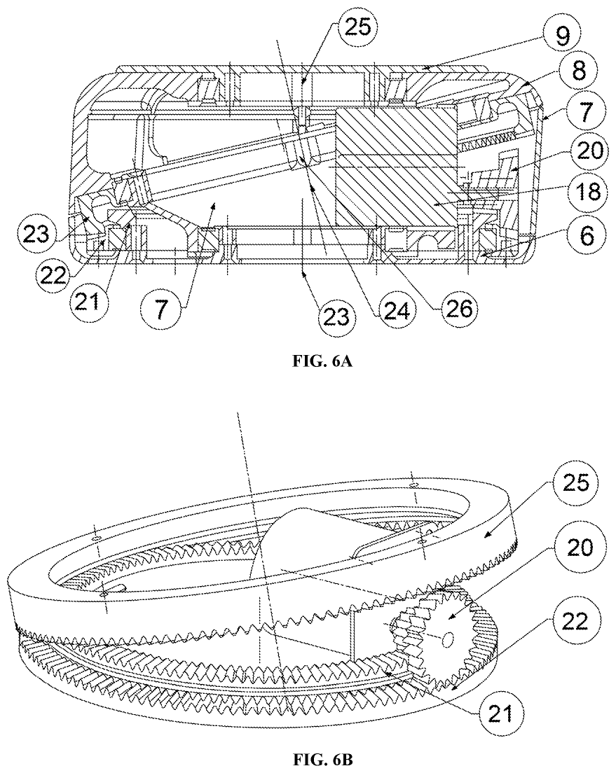

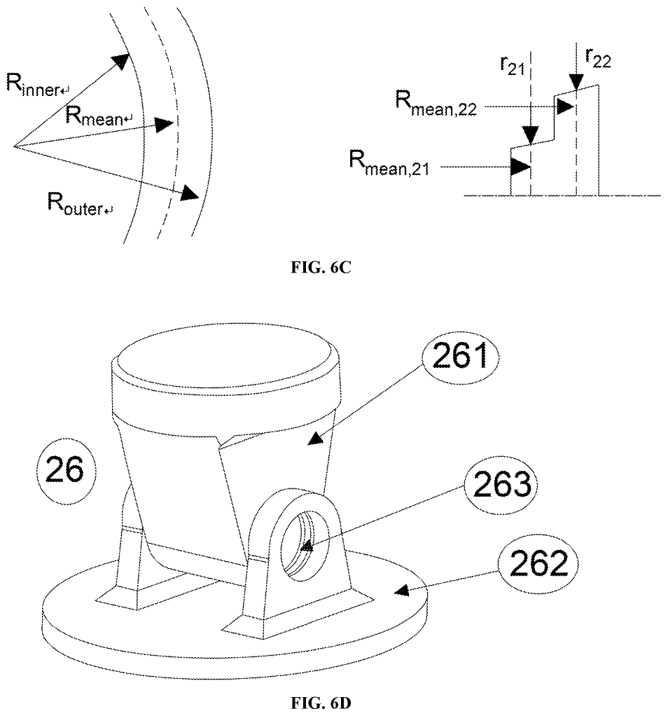

As shown in FIG. 6A and FIG. 6B, the angle rotation joint in the embodiment is driven by a single motor 18 and a driving wheel set 20 matched with the single motor 18. The motor 18 is arranged inside the angle rotation joint, and the motor 18 is fixedly connected with the second member 7 and provides shaft power to the driving wheel set 20.

Preferably, the motor 18 is an electric motor, such as a stepping motor or a servo motor, and is optionally provided with an internal gear box, such as a reduction gear box.

The driving wheel set 20 is formed by connecting two conical driving wheels with the diameter ratio of 1:2 in series. The driving wheel set 20 is matched with one driving ring set. The driving ring set includes an inner driving ring 21 and an outer driving ring 22 which are coaxially arranged. The inner driving ring 21 is fixedly connected with the first member 6 so as not to rotate. The outer driving ring 22 is slidably arranged on the first member 6 so as to freely rotate.

A driving wheel with a smaller diameter (hereinafter referred to as a small driving wheel) in the driving wheel set 20 is meshed with the inner driving ring 21. Therefore, when the motor 18 outputs shaft power to the driving wheel set 20, the small driving wheel can drive the motor 18 and the second member 7 fixedly connected with the motor 18 to rotate around a first rotation axis 23 along the inner driving ring 21. That is, rotary driving for the second member 7 is realized through an engagement between the small driving wheel and the fixed inner driving ring 21.

A driving wheel with a larger diameter (hereinafter referred to as a large driving wheel) in the driving wheel set 20 is meshed with the outer driving ring 22. The outer driving ring 22 is meshed with a second outer driving ring 25 fixed at the bottom of the third member 8. The outer driving ring 22 and the second outer driving ring 25 form an included angle α, and have the same diameter. The angle α is also an included angle between two ends of the second member 7 and the third member 8. Therefore, when the motor 18 outputs shaft power to the driving wheel set 20, the motor 18 drives the second member 7 to rotate, and drives the outer driving ring 22 to rotate in a direction opposite to the second member 7 simultaneously. The outer driving ring 22 is meshed with part of the second outer driving ring 25, so the second outer driving ring 25 can rotate in a direction (such as a clockwise direction) approximately the same as the outer driving ring 22, and then the second outer driving ring 25 drives the third member 8 fixedly connected with the second outer driving ring 25 to rotate towards a direction opposite to the second member 7. That is, reversely rotary driving for the third member 8 is realized through an engagement between the large driving wheel and the slidably arranged outer driving ring 22, and transmitting the driving force to the second outer driving ring 25 by the outer driving ring 22.

Reversely rotary driving for the second member 7 and the third member 8 is realized through the above-mentioned meshing relation between the driving wheel set 20 and the driving ring set. From the aforementioned description, single-degree-of-freedom motion can be realized only when the second member 7 and the third member 8 rotate respectively in directions opposite to each other at an equal angular velocity. Here, the reverse rotation at an equal angular velocity refers to rotation relative to a stationary reference object, such as the first member 6. However, it should be noted that since the first rotation axis 23 around which the second member 7 rotates is intersected with a second rotation axis 24 around which the third member 8 rotates, the reverse rotation of the second member 7 and the third member 8 described in the present disclosure is not a reverse rotation in a same plane. In a better mode of understanding, for example, when the second member 7 rotates clockwise, the third member 8 rotates counterclockwise.

In order to enable the second member 7 and the third member 8 to have the same rotary angular velocity, the driving wheel set 20 and the driving ring set should satisfy the following relationship:

Rₘₑₐₙ₂₂/Rₘₑₐₙ₂₁=(r₂₂−r₂₁)/r₂₁. Where, as shown in FIG. 6C, Rₘₑₐₙ is a mean radius of the driving ring, which refers to half of the sum of the inner ring radius and the outer ring radius of the inner driving ring or the outer driving ring; r is the mean radius of the driving wheel, which refers to half of the sum of the inner circular surface radius and the outer circular surface radius of the conical driving wheel.

In the embodiment, the diameter ratio of the large driving wheel to the small driving wheels is 1:2, which refers to the mean radius ratio of the driving wheels. That is, r₂₁:r₂₂ is 1:2. Due to the size limitation, the circumference ratio of the large and small driving wheels is also 1:2. Thus, when the motor 18 rotates at a certain rotary speed, large and small gears have the same angular velocity, but because of the difference in diameters, the linear velocity at a certain point on the large driving wheel is twice of that at a certain point on the small driving wheel. Assuming that the small driving wheel drives the motor 18 and the second member 7 to rotate clockwise at an angular velocity A at this time (since the inner driving ring 21 is fixed, the small driving wheel will drive the motor and the second member fixed to the motor to rotate relative to the inner driving ring), the large driving wheel can drive the outer driving ring 22, the second outer driving ring 25 and the third member 8 to rotate counterclockwise at an angular velocity 2A, but it should be noted that the counterclockwise rotation at the angular velocity 2A is relative to the driving wheel set 20, so the actual rotary speed of the third member 8 relative to the stationary reference object should also exclude the rotation of the driving wheel set 20 itself, namely, the counterclockwise rotation at the angular velocity A. As a result, relative to a stationary reference object, the second member 7 rotates clockwise at the angular velocity A and the third member 8 rotates counterclockwise at a linear velocity A.

According to the single-degree-of-freedom motion described in the present disclosure, a platform rotation axis 1 should be in a fixed and constant direction. However, in the present disclosure, the fourth member 9 used as a platform 9B or for supporting the platform 9B is slidably arranged at a top of the third member 8. Without limitation, the fourth member 9 can be driven by the third member 8 to rotate, thus causing a change in the direction of the platform rotation axis 1.

In order to prevent the fourth member 9 from being driven by the third member 8, in the embodiment, a flexible joint 26 is connected to the first member 6 and the fourth member 9. As shown in FIG. 6D, the flexible joint 26 includes an upper joint 261, a lower joint 262, and an articulated shaft 263 for articulating the upper joint 261 and the lower joint 262. Free ends of the upper joint 261 and the lower joint 262 are fixedly connected with the fourth member 9 and the first member 6, respectively, and upper and lower ends are rotatable around the articulated shaft 263. The articulated shaft 263 is parallel to the platform rotation axis 1.

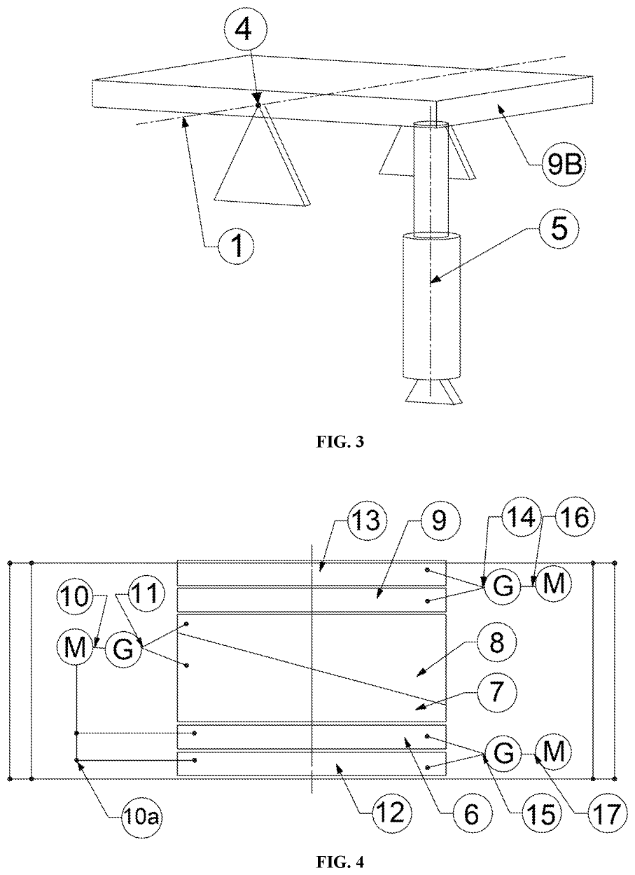

Through the aforementioned configuration, the platform rotation axis 1 is fixed, so that the platform 9B limited by the fourth member 9 only performs single-degree-of-freedom motion (similar to platform motion shown in FIG. 2 or FIG. 3) rotating around the platform rotation axis 1, and the single-degree-of-freedom motion can cause a maximum inclination angle of the platform 9B to be 2α.

The driving wheel set 20 and each driving ring may be gears and gear rings matched by teeth, and may also be a friction wheel and a friction ring having a surface with a high friction coefficient. Correspondingly, the meshing described in the embodiment may be meshing between a gear and a gear ring, or friction fit between the friction wheel and a friction ring or between friction rings.

### Embodiment 2

In the Embodiment 1, the motor 18 is fixedly connected with the second member 7, but this is not the only way of fixation. The embodiment provides a mirroring design of the scheme in the Embodiment 1, and the same platform motion mode may be realized in the mirroring design. In the mirroring design, the motor 18 is fixed on the third member 8, and provides shaft power for the driving wheel set 20. The inner driving ring 21 and the outer driving ring 22 in the driving ring set are respectively fixed and slidably supported on a lower surface of the fourth member 9, and the second outer driving ring 25 is fixed at the top of the second member 7. The driving wheel set 20 is meshed with the driving ring set connected to the fourth member 9.

Through other arrangement in the embodiment, the diameter ratio of the large and small driving wheels and the included angle between the outer driving ring 22 and the second outer driving ring 25 and the diameters of the outer driving ring 22 and the second outer driving ring 25 are the same in the Embodiment 1. Through the meshing of the driving wheel set 20 with the inner driving ring 21 and the outer driving ring 22 and the meshing of the outer driving ring 22 with the second outer driving ring 25, the mirroring design of the embodiment can also drive the second member 7 and the third member 8 to rotate respectively in directions opposite to each other at an equal velocity, so that the platform 9B limited by the fourth member 9 performs single-degree-of-freedom motion around the platform rotation axis 1.

### Embodiment 3

The embodiment provides a two-degree-of-freedom motion system. The two-degree-of-freedom motion system is realized by additionally arranging some members to the single-degree-of-freedom angle rotation joint provided in the Embodiment 1 or Embodiment 2.

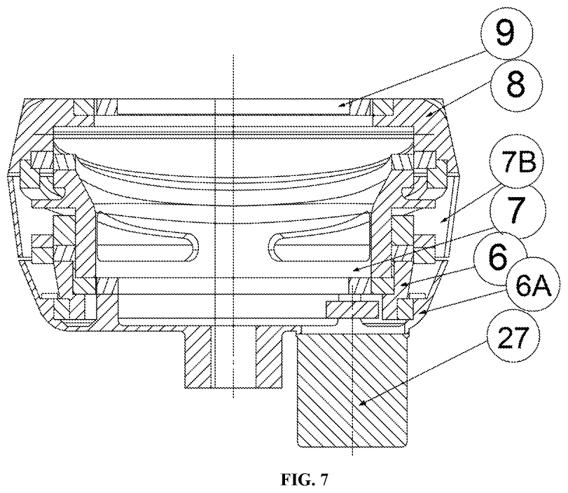

Specifically, the motion system as shown in FIG. 7 can change the direction of the platform rotation axis 1. The first member 6 rotates around the first rotation axis 23 relative to an additional static section 12 by additionally arranging the bottom motor 27, namely the rotation of the platform rotation axis 1 in a platform plane can be realized. The modification can change the single-degree-of-freedom angle rotation joint described in the Embodiments 1-2 to a motion system with two degrees of freedom: any direction of the platform rotation axis 1 in the platform plane can be achieved by driving the first member 6 to rotate around the rotation axis 23. In the scheme of the embodiment, the flexible joint 26 described in the Embodiment 1 is still connected with the fourth member 9 and the first member 6, so as to prevent the fourth member 9 from being driven by the third member 8.

A scheme that protective shells, such as a first protective shell 6A arranged outside the first member 6 and a second protective shell 7B arranged outside the second member 7, are arranged outside the member is shown in FIG. 7. The protective shell shields the member, but the protective shell cannot share the load and also cannot transmit the torque.

It should be noted that although the embodiment is also a two-degree-of-freedom motion system driven by two motors, the embodiment is substantially different from those two-degree-of-freedom motion systems described in the background art. In the prior art, the two-degree-of-freedom motion system respectively drives the second member 7 and the third member 8 by using two motors. However, in the embodiment, the second member 7 and the third member 8 are still driven only by a single motor; and the other motor is used for rotating the second member 7 and the third member 8 at the same time.

### Embodiment 4

The embodiment provides a multi-degree-of-freedom motion system. The multi-degree-of-freedom motion system is realized by further additionally arranging or replacing some members to the two-degree-of-freedom motion system provided in the Embodiment 3.

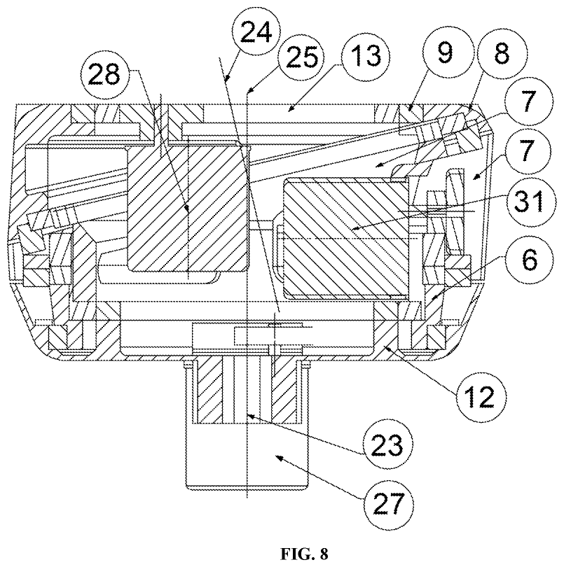

Specifically, the motion system as shown in FIG. 8 is based on the two-degree-of-freedom motion system as shown in FIG. 7, but the flexible joint 26 connected the fourth member 9 and the first member 6 is eliminated while the fourth member 9 is driven to rotate around the fourth rotation axis 25 by additionally arranging the top motor 28 to be in driving fit with the fourth member 9. Reverse compensating rotation can be provided for the fourth member 9 by properly controlling the rotation direction and rotary speed of the top motor 28. The compensating rotation is used for counteracting the rotation produced by the fourth member 9 due to the driving of the third member 8, so that the same effect that the flexible joint 26 is still not canceled can be achieved. Of course, the top motor 28 can also provide other rotary driving for the fourth member 9, so that the motion system in the embodiment becomes a motion system with three degrees of freedom.

In another aspect, if the top motor 28 in the embodiment is used to replace the bottom motor 27 in the Embodiment 3, that is, only the top motor 28 is additionally arranged on the basis of the Embodiment 1 or Embodiment 2, but the bottom motor 27 is not provided, the motion system may have two degrees of freedom equivalent as that in the Embodiment 3. However, it should be noted that for the two-degree-of-freedom motion system provided in the embodiment and a two-degree-of-freedom driving system provided in the Embodiment 3, except that the additionally arranged motors are located at different positions, the flexible joint 26 is also canceled in the scheme of the embodiment.

The embodiment also provides a scheme that a plurality of angle rotation joints each having a single degree of freedom are stacked on each other to obtain a motion system having multiple degrees of freedom.

### Embodiment 5

Several schemes that the motor and the driving assembly are arranged inside the angle rotation joint are shown in the Embodiments 1-4. In some cases, the diameter of each member of the angle rotation joint is so small that the internal space of the angle rotation joint does not allow the motor and the driving assembly to be arranged. In order to overcome such problem, the embodiment provides a driving scheme that the motor and the driving assembly are arranged outside the angle rotation joint.

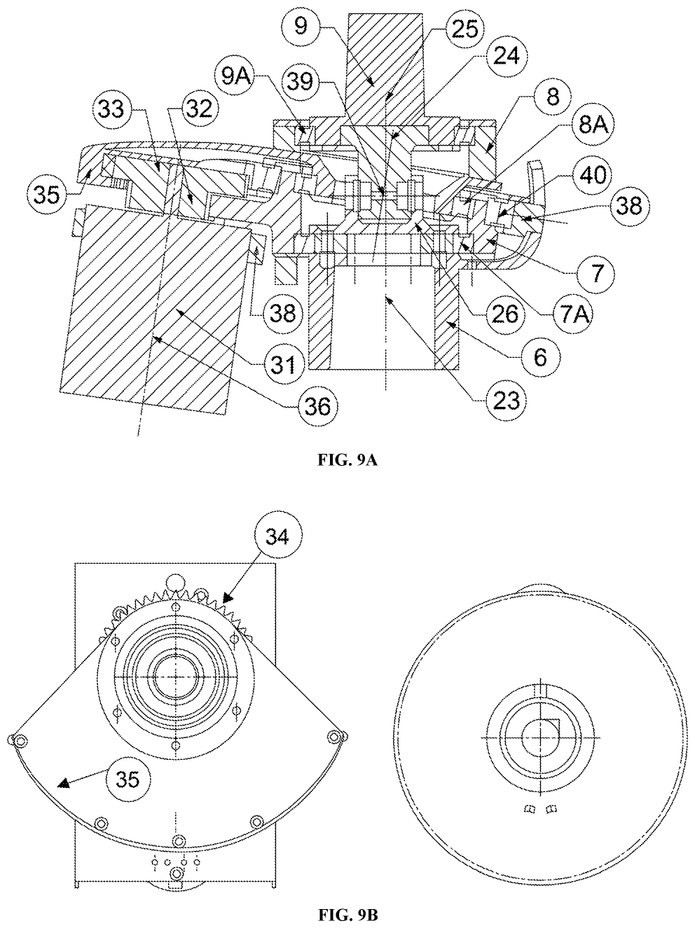

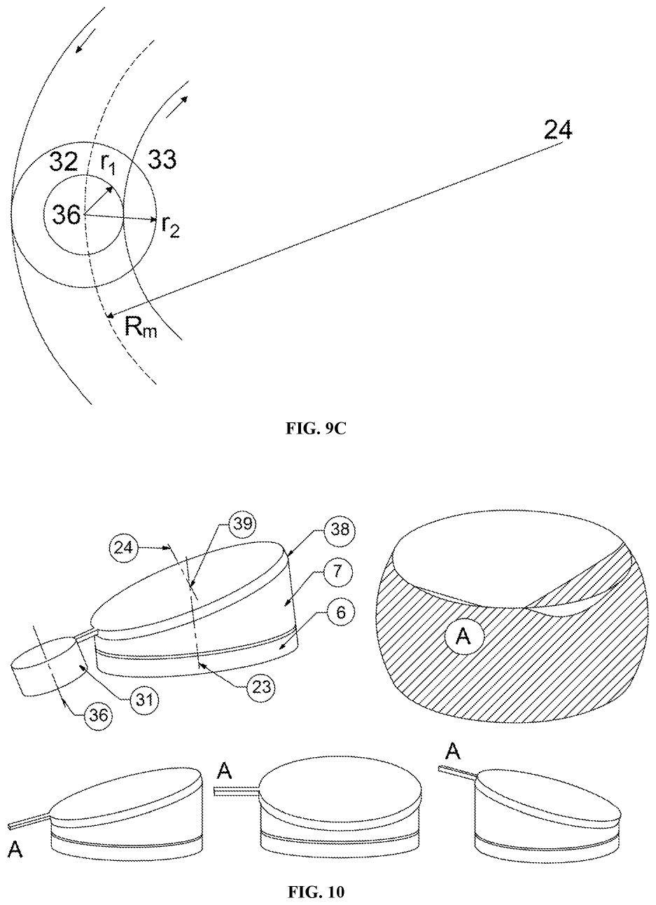

Specifically, as shown in FIG. 9A and FIG. 9B, the angle rotation joint still includes a first member 6, a second member 7, a third member 8 and a fourth member 9 which are stacked on each other. The four members are in sliding contact with each other, and the sliding contact can be achieved by means of the structures of bearings 7a, 8a, 9a. The inclination angles at both ends of the second member 7 and the third member 8 and the rotation axes around which the second member 7 and the third member 8 rotate are the same as those described in the summary of the present disclosure and the Embodiment 1, which are not changed or replaced in the embodiment.

Different from the aforementioned embodiment, the inner space of the four members of the angle rotation joint is small, so the motor is not arranged inside the angle rotation joint, but is arranged outside the angle rotation joint as shown in FIG. 9A. In order to distinguish from the motor 18 arranged inside the angle rotation joint described in the aforementioned embodiment, the motor positioned outside the angle rotation joint is referred to as the outer motor 31 in the embodiment. The outer motor 31 is connected with a second driving wheel set and outputs shaft power to the second driving wheel set. The second driving wheel set is formed by connecting a second small wheel 32 and a second large wheel 33 in series with each other. An outer driving wheel 34 is integrally arranged outside the second member 7 or fixedly arranged by clamping, bolted connection and other manners. The outer driving ring 35 is integrally arranged outside the third member 8 or fixedly arranged by clamping, bolted connection and other manners.

As shown in FIG. 9B, the outer driving ring 35 is fixed to the outside of the third member 8 by means of a cover-like member. Of course, the outer driving ring 35 and the third member 8 can also be fixed by means of ribs or other forms of connectors. Two forms of the outer driving ring 35, such as a ¼ ring (90-degree ring) and a complete ring, are shown in FIG. 9B, respectively. Of course, the outer driving ring 35 can also be other forms of partial rings, such as a ½ ring, a ⅓ ring, a ¾ ring and the like. The specific selection can be determined according to the angle at which the third member 8 needs to be rotated. However, in fact, since the second member 7 and the third member 8 rotate in reverse directions at the same speed, the second member 7 and the third member 8 only need to rotate 90 degrees, respectively, so as to achieve a relative rotation of 180 degrees, that is, the outer driving ring 35 only needs to be a ¼ ring at least, and the rotation of the platform around the platform rotation axis 1 in all angular ranges (namely 2α) can be realized. Therefore, although it is technically feasible to select a ring larger than ¼ as the outer driving ring 35, it is not economically necessary.

Still as shown in FIG. 9A, the diameter of the outer driving wheel 34 is smaller than that of the outer driving ring 35, and the outer driving wheel 34 is engaged with the near side (referring to the side near the axis 23) of the second small wheel 32, and the outer driving ring 35 is engaged with the far side (referring to the side away from the axis 23) of the second large wheel 33. When the outer motor 31 outputs shaft power to the second driving wheel set, the second small wheel 32 and the second large wheel 33 rotate in the same direction at an equal angular velocity. At the same time, the second small wheel 32 drives the second member 7 to rotate by engaging with the outer driving wheel 34, and the second large wheel 33 drives the third member 8 to rotate in the opposite direction by engaging with the outer driving ring 35.

However, as mentioned above, in order to realize the single-degree-of-freedom motion of the platform 9B limited by the fourth member 9, the second member 7 and the third member 8 should have the equal angular velocity in addition to the reverse rotation.

In the scheme of the embodiment, the control of the rotary speed of the second member 7 and the third member 8 is achieved by the arrangement position of the outer motor 31.

Specifically, as shown in FIG. 9C, the radius of the second small wheel 32 is r₁, the radius of second large wheel 33 is r₂, and the distance from the motor axis 36 of the outer motor 31 to the second rotation axis 24 is Rₘ, where Rₘ should satisfy the following relationship:

Rₘ=2(r₁·r₂)/(r₂−r₁).

Similar to the scheme in the first embodiment, in order to prevent the fourth member 9 from being driven by the third member 8, in the embodiment, the flexible joint 26 in the Embodiment 1 is also used for connecting the fourth member to the first member 6, and the articulated shaft 263 of the flexible joint 26 is parallel to the platform rotation axis 1.

In the embodiment, the motor axis 36 should be always parallel to the second rotation axis 24, which is very important to maintain Rₘ constant and have the second driving wheel set to engaging well with the outer driving wheel 34 and the outer driving ring 35. Since the rotation of the second member 7 and the third member 8 may cause a change in the direction of the second rotation axis 24, it is necessary to properly mount the outer motor so that the parallel relationship between the motor axis 36 and the second rotation axis 24 can be maintained all the time.

In the embodiment, the outer motor 31 is provided with a mounting base 38. The mounting base 38 includes a mounting part for being fixed with the motor and a sliding part for being in sliding fit with the top of the second member 7 or the bottom of the third member 8.

Although the direction of the second rotation axis 24 may change during the process of rotation, the intersection (hereinafter referred to as a surrounding point 39) between the second rotation axis 24 and the first rotation axis 23 remains unchanged. A plane passing through the surrounding point 39 and parallel to an inclined top surface of the second member 7 in the embodiment is defined as a mounting surface. The motor mounting base 38 is located on the mounting surface, so the intersection of the motor axis 36 with the mounting surface passing through the surrounding point 39 is defined as a mounting point A (the mounting point A may be any selected point on the mounting surface where the outer motor 31 or the mounting base 38 is located). Without limitation, when the second member 7 rotates around the first rotation axis 23, the mounting surface also rotates around the surrounding point 39 in order to be parallel to the inclined top surface of the second member 7. Since the mounting point A has been selected, the distance from the mounting point A to the surrounding point 39 remains unchanged, and the mounting point A can form a spherical surface as shown in FIG. 10 due to the rotation of the mounting surface.

In order to keep the motor axis 36 parallel to the second rotation axis 24, the mounting point A should be allowed to move only in a selected longitude line of a sphere shown in FIG. 10. At the same time, the motor axis 36 can rotate around the mounting point A.

It is required that after the outer motor 31 is mounted at a fixed distance from the second rotation axis 24 through the mounting base 38, when the second member 7 rotates around the first rotation axis 23, the outer motor 31 should not rotate around the first rotation axis 23 along with the second member 7, and the distance from the second rotation axis 24 is maintained. Therefore, the outer motor 31 has to be connected with a stationary member to restrain such rotation. In the embodiment, the stationary member is the first member 6.

In the embodiment, the connection of the mounting base 38 with the first member 6 is achieved by a coupling 48. The coupling 48 is a compliant coupling capable of transmitting torque and allowing dislocation between the ends (referring to both ends of the coupling) caused by rotation of the second member 7. For example, the coupling 48 may be a universal joint or a spring coupling (as shown in FIG. 23). Of course, the coupling 48 may be other compliant couplings well known in the art. One end of the coupling 48 is connected with the first member 6, and the other end of the coupling 48 extends to the surrounding point 39. The mounting base 38 also includes a connecting part extending to the surrounding point 39 for being connected with the coupling 48.

### Embodiment 6

Based on the Embodiment 5, the embodiment provides an alternative scheme of the coupling 48. Since the coupling 48 described in the Embodiment 5 has to be connected to the mounting base 38 at the surrounding point 39, the coupling 48 needs to be arranged inside the angle rotation joint. However, due to limitation on space or cost, it is not always possible to add a connection of an internal coupling 48 between the mounting base 38 and the first member 6.

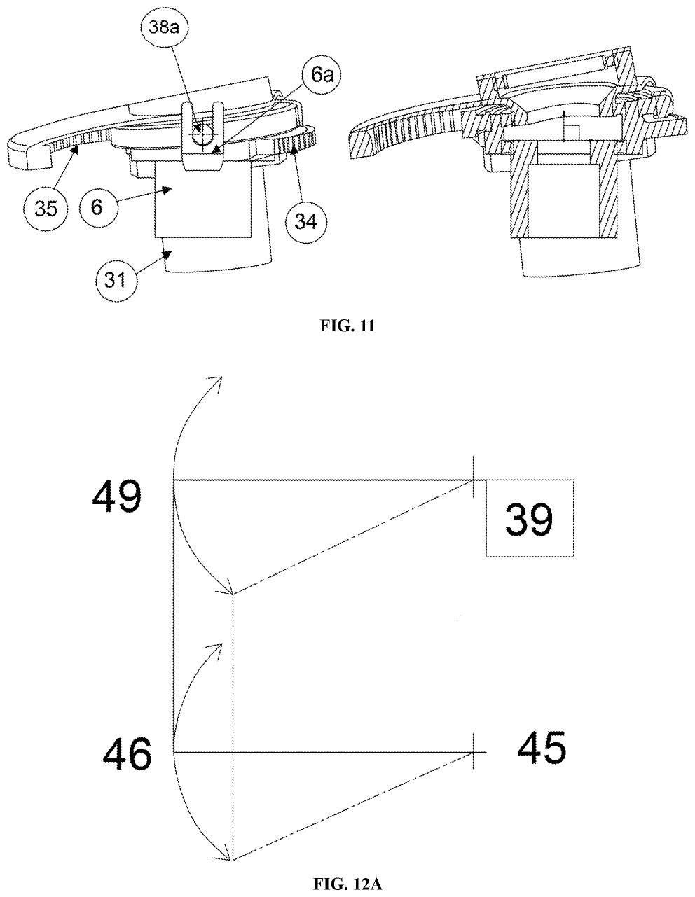

As an alternative scheme, the embodiment provides a guide pin mechanism for connecting the mounting base 38 and the first member 6. As shown in FIG. 9A and FIG. 11, the guide pin mechanism includes a columnar pin 38a. The pin 38a is a part of the mounting base 38 and located on one side, away from the mounting part, of the sliding part. The guide pin mechanism also includes an arc-shaped guide groove 6b, and the arc follows a spherical surface with the surrounding point 39 as a center of sphere. The spherical surface can be different from the spherical surface on which the mounting point A is located. The arc of the guide groove 6b is arranged in a direction of the longitude line of the spherical surface. The guide groove 6b is rigidly connected to the first member 6. The pin 38a is located in the guide groove 6b, and is limited. Therefore, the pin 38a moves only along the arc arranged in the direction of the longitude line, and the motor mounting point A is limited to move only in a direction of the longitude line aforementioned and cannot rotate around the first rotation axis 23.

### Embodiment 7

The embodiment provides another alternative scheme of the coupling 48. The guide pin mechanism provided in Embodiment 6 has the advantages of simple structure, low cost and light weight. However, there is a large local stress and a high wear risk between the pin and the guide groove.

As shown in FIG. 12A, the alternative scheme provided by the embodiment is based on a four-bar mechanism. The four-bar mechanism consists of four pivot points 39, 45, 46 and 49 as a parallelogram, where the pivot point 39 is a precessional motion point of the mounting base 38, namely the aforementioned surrounding point, and the mounting base 38 is still supported by the second or third member through sliding contact. The pivot point 45 is located on the first rotation axis 23 at a certain distance from the pivot point 39. A connecting rod 44 is connected with the pivot point 45 and, and is provided with an additional pivot point 46 at the other end. The direction of the connecting rod 44 depends on the pivot point 49, and the pivot point 49 is at a convenient position on the mounting base 38. The phantom line between the pivot points 46 and 49 is parallel to the phantom line between the pivot points 39-45. Furthermore, the phantom line between the pivot points 39 and 49 is always parallel to the phantom line between the pivot points 45 and 46.

An arrangement example of the four-bar mechanism is shown in FIG. 12B, where the pivot point 45 corresponds to two rotation axes fixed at opposite positions on the first member 6. The pivot point 46 corresponds to a rotation axis arranged outside the first member 6, and two rotation axes corresponding to the pivot point 45 are connected to two ends of the rotation axis corresponding to the pivot point 46 through a connecting rod 44, respectively. The rotation axis corresponding to the pivot point 46 is also connected with the pivot point 49 by a connecting rod. The pivot point 49 is located on the mounting base 38, and is connected with the connecting rod through a spherical hinge structure. In addition to serving as the pivot point 49 on the four-bar mechanism, the spherical hinge structure also allows the mounting base 38 to rotate around a connecting line of the mounting point A and the surrounding point 39.

The four-bar mechanism in the embodiment allows the mounting base 38 to be rotated in three directions, but may restrain the rotation of the whole mounting base 38 around the first rotation axis 23.

### Embodiment 8

Due to space limitation and reliability, the guide pin mechanism in the Embodiment 6 and the four-bar mechanism in the Embodiment 7 may be infeasible. The embodiment provides an alternative scheme that the rotation of the whole mounting base 38 is restrained by using the second member 7.

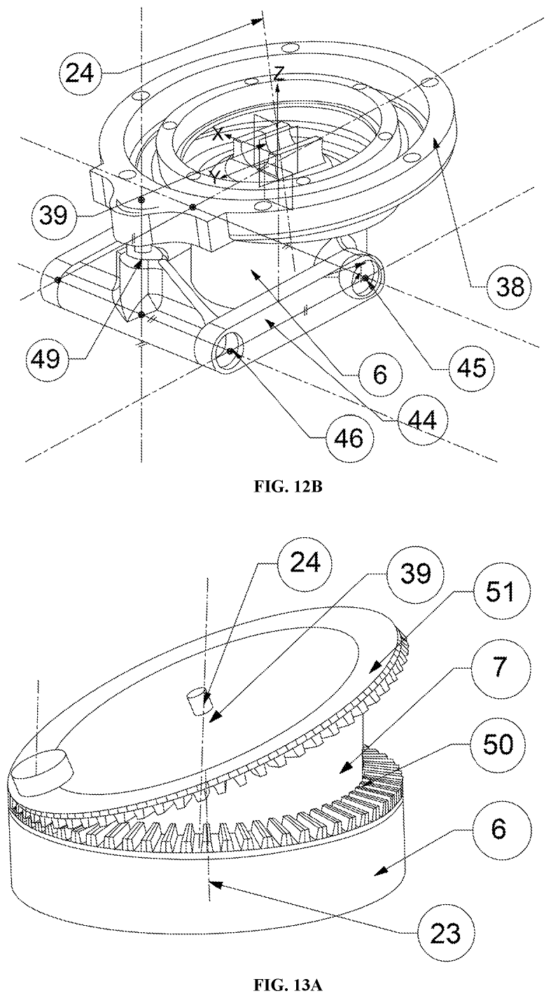

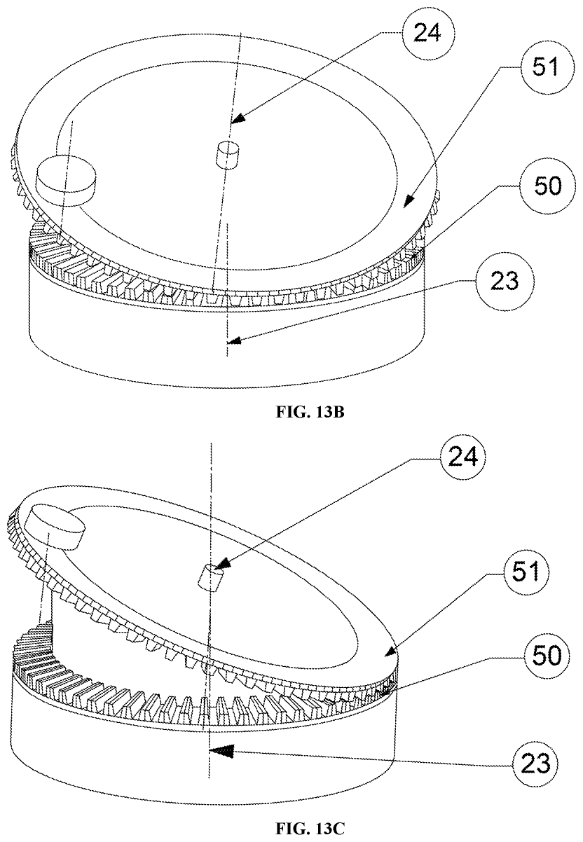

As shown in FIG. 13A and FIG. 13C, a restraint gear ring 51 is fixedly arranged on the mounting base 38. Further, a fixed gear ring 50 always keeping meshing with the restraint gear ring 51 is fixedly arranged on the outer side of the first member 6. Since the fixed gear ring 50 does not rotate, the rotation of the fixed gear ring 51 around the first rotation axis 23 may be restrained through the meshing with the restraint gear ring 51, and then the rotation of the mounting base 38 around the first rotation axis 23 is restrained. The restraint gear ring 51 should be fixed to the mounting base 38 in such a manner that the axis of the restraint gear ring 51 is always parallel to the second rotation axis 24. The direction of the inclined surface at the upper end of the second member 7 may change along with the rotation of the second member 7, and then the postures of the mounting base 38 and the restraint gear ring 51 are driven to change, but only the meshing points of the restraint gear ring 51 with the fixed gear ring 50 change and the restraint gear ring 51 does not rotate, since the fixed gear ring 50 meshed with the restraint gear ring 51 does not rotate, which may be illustrated by means of a button-like protrusion located on the left side of the restraint gear ring 51 in FIG. 13A to FIG. 13C, as a reference. During the rotation of the second member 7, only the meshing points of the restraint gear ring 51 with the fixed gear ring 50 change, but this reference is always located on the left side of the picture, that is, the restraint gear ring 51 does not rotate around the first rotation axis 23.

It should be understood that instead of teeth of a gear, the meshed gear ring in the embodiment may also be replaced by a surface with a high coefficient of friction such as rubber or silicon material, which may achieve the same restraint effect as the meshing of the gear ring. Compared with a gear meshing scheme, the high friction surface has the advantages of lower cost and complexity. However, the high friction surface has the disadvantages that there is frictional loss after long-term use and requires tight installation and coordination to ensure appropriate pressure between friction surfaces, so the high friction surface is sensitive to assembly accuracy.

### Embodiment 9

Several schemes that a driving wheel set composed of gears or friction wheels is directly meshed with the gear ring or the friction ring to drive the second member 7 and the third member 8 are shown in the Embodiments 5-8. It is known that the two directly meshed gears always rotate in opposite directions (excluding the meshing condition of the second large wheel 33 with the outer driving ring 35 in FIG. 9A). The embodiment provides an alternative scheme of driving the third member 8 in the Embodiment 5.

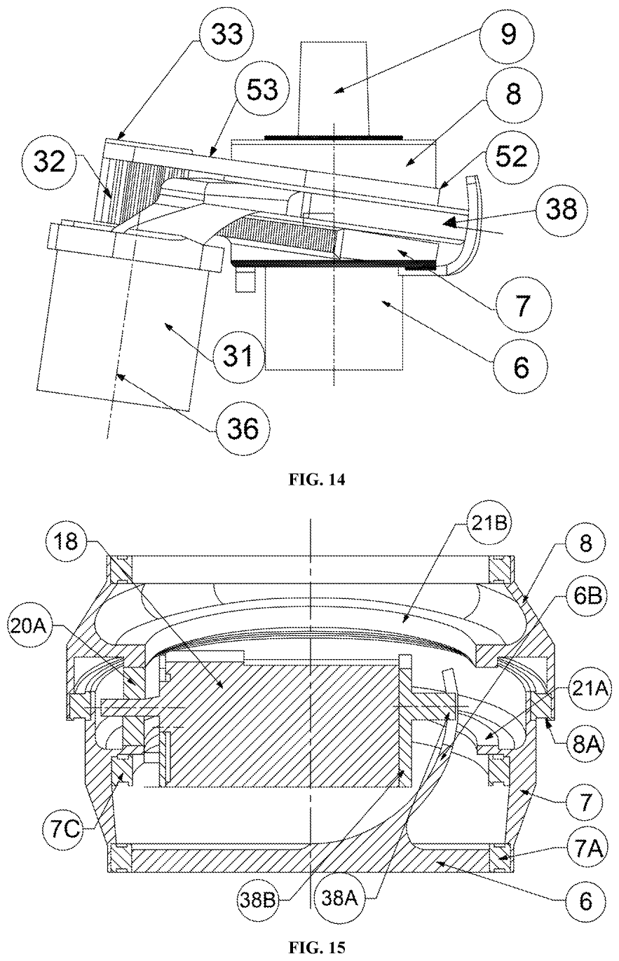

Specifically, as shown in FIG. 14, in the Embodiment 5, the outer driving ring 35 arranged outside the third member 8 is replaced by a pulley 52, and the pulley 52 is a belt pulley or a chain wheel. Correspondingly, the second large wheel 33 is also replaced by a belt pulley or a chain wheel. At the same time, the second large wheel 33 and the pulley 52 are connected through a belt or a chain 53. In the embodiment, other members remain unchanged on the basis of the Embodiment 5.

Under this configuration, the second small wheel 32 is meshed with the outer driving wheel 34 fixed on the outer side of the second member 7, so the outer driving wheel 34 will rotate reversely with respect to the second small wheel 32. The second large wheel 33 and the pulley 52 fixed to the outside of the third member 8 are driven by a belt or a chain 53, so the pulley 52 will keep rotating in a same direction as the second large wheel 33. Finally, this configuration may drive the second member 7 and the third member 8 to rotate respectively in directions opposite to each other at an equal angular velocity, so that the platform limited by the fourth member 9 performs single-degree-of-freedom rotation around the platform rotation axis 1.

It should be noted that although FIG. 14 shows that the pulley 52 is arranged on the third member 8, it should be understood that the same effect can be achieved if the pulley 52 is arranged on the second member 7 and the outer driving wheel 34 is arranged on the third member 8.

Compared with gear pair connection schemes provided in the Embodiments 5-8, the belt or chain connection scheme provided in the embodiment has the advantages that the pulley transmission is more affordable and the required space is smaller.

### Embodiment 10

The aforementioned Embodiments 1-2 describe a driving mode in which the motor is arranged inside the angle rotation joint and fixed to the second member 7 or the third member 8. The Embodiments 5-8 describe that the motor is slidably arranged outside the angle rotation joint and passes through a motor anti-rotation apparatus (the coupling 48 in the Embodiment 5, the guide pin mechanism in the Embodiment 6, the four-bar mechanism in the Embodiment 7, and the restraint gear ring and the fixed gear ring in the Embodiment 8).

However, in fact, the motor anti-rotation apparatus in the Embodiments 5-8 does not only cooperate with an external motor. The apparatus can also cooperate with the built-in motor placed inside the angle rotation joint and realize the driving for the angle rotation joint.

The embodiment provides a single-degree-of-freedom angle rotation joint with such cooperation. As shown in FIG. 15, the angle rotation joint is still composed of a non-rotating first member 6 located at the bottom as a basis, a second member 7 which is arranged at the top of the first member 6 and rotates around the first rotation axis 23, a third member 8 with an inclined bottom which is matched with the inclined top of the second member 7 and rotates around the second rotation axis 24, and a fourth member 9 arranged at the top of the third member 8. The four members are in sliding fit. For example, the bearings 7a, 8a and 9a are in sliding fit.

In the embodiment, the motor 18 is still located inside the angle rotation joint. However, the difference from the Embodiments 1-2 lies in that the motor 18 is no longer fixedly connected with the second member 7 or the third member 8, but is slidably connected with the second member 7. The sliding connection here is realized through the inner bearing 7c. The inner bearing 7c is parallel to the bearing 8a arranged between the second member 7 and the third member 8, and also parallel to the inclined top of the second member 7 and/or the inclined bottom of the third member 8. Therefore, the plane on which the inner bearing 7c is located also has an included angle of α with respect to the first member 6. On the other hand, the second inner driving ring 21a is fixed inside the second member 7 in a manner of being parallel to the inner bearing 7c, and the third inner driving ring 21b is fixed inside the third member 8 in a manner of being parallel to the inner bearing 7c. A set distance is kept between the second inner driving ring 21a and the third inner driving ring 21b.

The motor 18 is rigidly connected with the inner bearing 7c through a motor support 38b, and the motor 18 is provided with a driving wheel. In order to be different from other driving wheels in the present disclosure, the driving wheel is defined as an inner driving wheel 20a in the embodiment. The inner driving wheel 20a here is different from the driving wheel set 20 in the Embodiment 1, and includes only a single wheel. The inner driving wheel 20a is arranged between the second inner driving ring 21a and the third inner driving ring 21b, and the diameter of the inner driving wheel 20a is matched with the spacing between the second inner driving ring 21a and the third inner driving ring 21b, so that the inner driving wheel 20a can be engaged with the second inner driving ring 21a and the third inner driving ring 21b at the same time. Therefore, when the motor 18 outputs shaft power to the inner driving wheel 20a, the motor 18 will drive the second member 7 and the third member 8 to rotate respectively in directions opposite to each other at an equal angular velocity.

Since the motor 18 is slidably connected with the member of the angle rotation joint, the same requirement for limiting the rotation of the motor 18 around the first rotation axis 23 exists in the embodiment as in the Embodiments 5-8. However, this requirement can be achieved by means of the motor anti-rotation apparatus described in the Embodiments 5-8.

The motor anti-rotation apparatus the same as that in the Embodiment 6, namely the guide pin mechanism, is shown in FIG. 15, where one end, away from the inner driving wheel 20a, of the motor support 38b is provided with a pin 38a. The pin 38a is limited in the arc-shaped guide groove 6b. The arc follows a spherical surface with the surrounding point 39 as a center of sphere, and the arc of the guide groove 6b is arranged in a direction of the longitude line of the spherical surface. The guide groove 6b is rigidly connected to the first member 6.

It should be understood that although only one motor anti-rotation apparatus is shown in the embodiment, the coupling 48 described in the Embodiment 5, the four-bar mechanism described in the Embodiment 7, and the restraint gear ring and the fixed gear ring mechanism described in the Embodiment 8 can also be applied to this embodiment to limit the rotation of the motor 18 around the first rotation axis 23. These apparatuses can be connected to the motor support 38b in the embodiment in the same manner as shown in the corresponding embodiments, which will not be described again in this embodiment.

On the other hand, the fourth member 9 still may be connected to the first member 6 through the flexible joint 26 to prevent from rotating along with the third member 8, so that the angle rotation joint in the embodiment can only perform single-degree-of-freedom rotation around the platform rotation axis 1.

### Embodiment 11

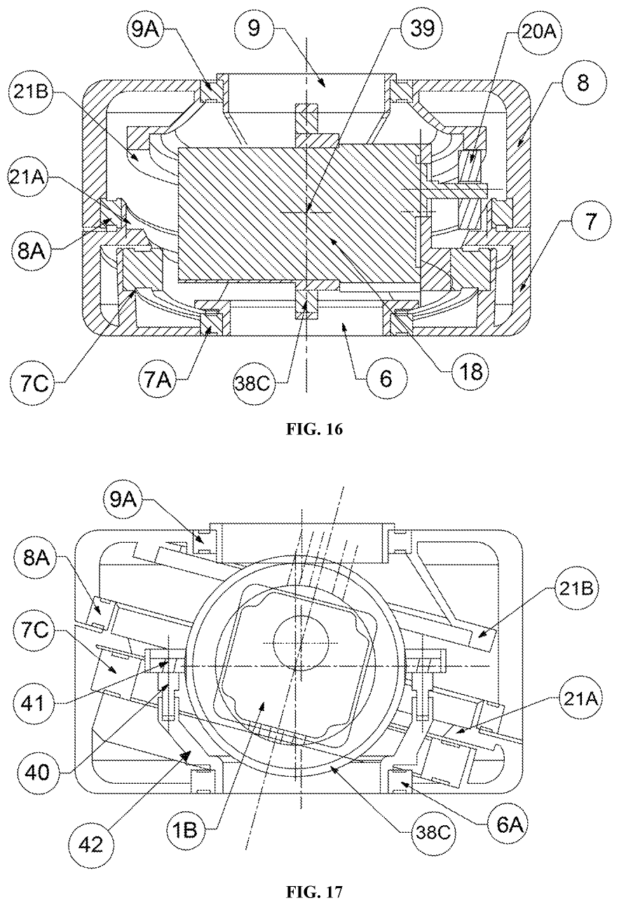

The embodiment provides another single-degree-of-freedom angle rotation joint with a built-in motor. As shown in FIG. 16, the angle rotation joint is the same as that in the aforementioned embodiment, and still includes four members which are stacked on each other in sequence. The four members are slidably connected with each other by means of bearings 7a, 8a, 9a, respectively, where the bearing 8a for connecting the second member 7 and the third member 8 is parallel to the inclined top of the second member 7 and/or the inclined bottom of the third member 8.

The second inner driving ring 21a is fixed inside the second member 7 in a manner of being parallel to the inclined end of the second member 7, and the third inner driving ring 21b is fixed inside the third member 8 in a manner of being parallel to the inclined bottom of the third member 8. A set distance is maintained between the second inner driving ring 21a and the third inner driving ring 21b.

In the embodiment, the motor 18 is still located inside the angle rotation joint, and is rigidly connected to the inner bearing 7c to realize sliding connection with the second member 7 through the inner bearing 7c. The inner bearing 7c is parallel to the bearing 8a arranged between the second member 7 and the third member 8. In the embodiment, the motor 18 is also provided with a bearing set. The bearing set allows the motor to perform a pitching action and a rotary rocking action around the motor axis, but the bearing set prevents the motor 18 from performing an integral rotation around the first rotation axis 23 because the motor 18 is rigidly connected to the inner bearing 7c. Therefore, the bearing set here is essentially also a motor anti-rotation mechanism.

Specifically, as shown in FIG. 16 and FIG. 17, the bearing set includes an annular bearing 38c and at least one small bearing 43 fixed to one side of the annular bearing 38c. The annular bearing 38c includes a fixed ring and a moving ring which are mutually slidable and coaxially arranged. The moving ring is located on the inner side of the fixed ring. The fixed ring also may include a frame structure fixed on the outside of the fixed ring. The axis of the annular bearing 38c passes through the surrounding point 39. The motor 18 is rigidly connected with the moving ring of the annular bearing 38c, so the annular bearing 38c allows the motor to perform the rotary rocking action around the axis of the annular bearing 38c. The small bearing 43 is fixed with the fixed ring of the annular bearing 38c. The small bearing 43 may be a spherical bearing or another annular bearing, and allows the motor 18 to perform an up-and-down pitching motion. The axis around which the pitching motion is performed is a connecting line from the spherical center of the spherical bearing to the surrounding point 39 or an axis of the annular small bearing 43. The axis of the annular small bearing 43 passes through the surrounding point 39. At the same time, the axis around which the pitching motion is performed should keep vertical to the axis of the annular bearing 38c. The quantity of the small bearings 43 may be one or two (although the condition that two small bearings 43 are used is shown in FIG. 16, the purpose of the embodiment can be realized by only a single small bearing 43 actually since the motor 18 is rigidly connected with the inner bearing 7c.).

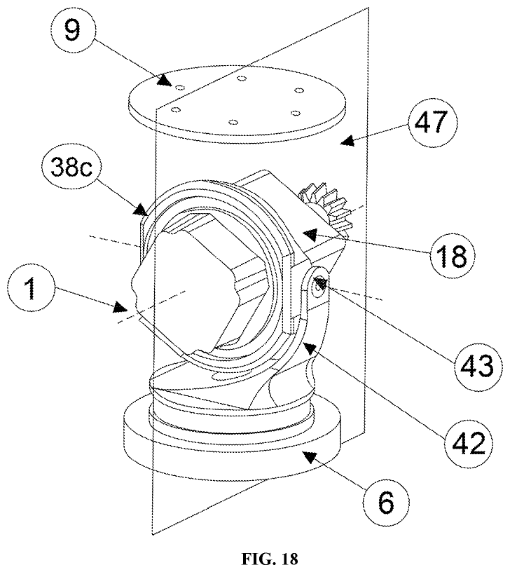

As shown in FIG. 18, when the small bearing 43 is another annular bearing, one of the inner ring or the outer ring is fixed to one side of the fixed ring for the annular bearing 38c, and the other ring not fixed to the annular bearing 38c is fixed to the first member 6 through the side stand 42. At the same time, the axis of the small bearing 43 serves as a rotation axis around which the motor 18 moves during pitching motion. Since the motor 18 is limited from rotating around the first rotation axis 23, the pitching action of the motor 18 is limited into a specific plane, and the plane is defined as a pitching plane 47 in the present disclosure. When the first member 6 is placed horizontally, the pitching plane 47 is a vertical plane and passes through the surrounding point 39. The axis of the annular small bearing 43 should be vertical to the pitching plane 47 and passes through the surrounding point 39. The axis of the annular bearing 38c, as the rotation axis around which the motor 18 rotates and swings, is always located in the pitching plane 47 and also passes through the surrounding point 39.

When the small bearing 43 is a spherical bearing, as shown in FIG. 17, the small bearing 43 includes a ball-head screw 40 and an inner spherical shaft sleeve 41 matched with a ball head of the ball-head screw. The fixed ring of the annular bearing 38c is rigidly connected with the inner spherical shaft sleeve 41. A threaded end of the ball-head screw is arranged downwards and fixedly connected with the first member 6 through the side stand 42, where the connecting line between the spherical center of the spherical bearing and the surrounding point 39 is the rotation axis around which the motor 18 moves during performing the pitching action, and should also be vertical to the aforementioned pitching plane 47. In this arrangement, since one end of the motor 18 is rigidly connected with the inner bearing 7c, and the other end of the motor 18 is connected with the spherical bearing. Therefore, the pitching action with the connecting line between the spherical center of the spherical bearing and the surrounding point 39 as the rotation axis can be performed, but the motor 18 can be prevented from rotating integrally around the first rotation axis 23 (since the spherical center of the spherical bearing does not coincide with the surrounding point 39 that the imaginary integral rotation needs to rotate around, the integral rotation may be limited). Similarly, since the motor 18 is rigidly connected with the inner bearing 7c, when the second member 7 rotates, the tilt direction of the inner bearing 7c changes along with the rotation, and the annular bearing 38c can allow the motor 18 to perform the rotary rocking action around the axis of the annular bearing 38c to adapt to the change in the tilt direction of the inner bearing 7c when the tilt direction of the inner bearing 7c changes.

In the embodiment, a flexible joint 26 is still used for connecting the first member 6 and the fourth member 9 to prevent the fourth member 9 from rotating along with the third member 8. In this case, the platform rotation axis 1 will remain coaxial with the articulated shaft 263 of the flexible joint 26.

The embodiment provides three arrangement manners of the flexible joint 26 for explaining the coaxial relationship between the platform rotation axis 1 and the articulated shaft 263 in detail.

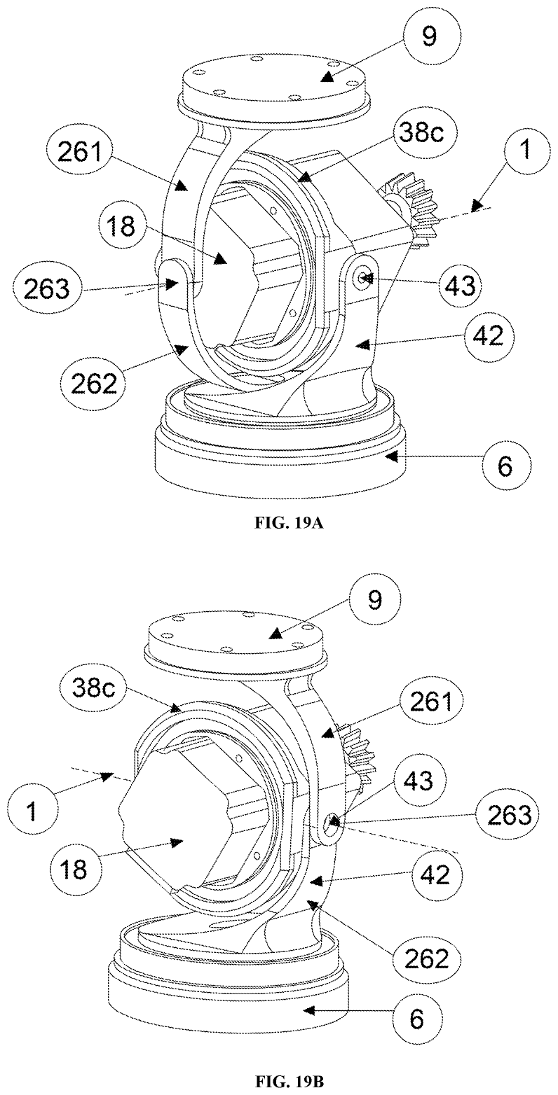

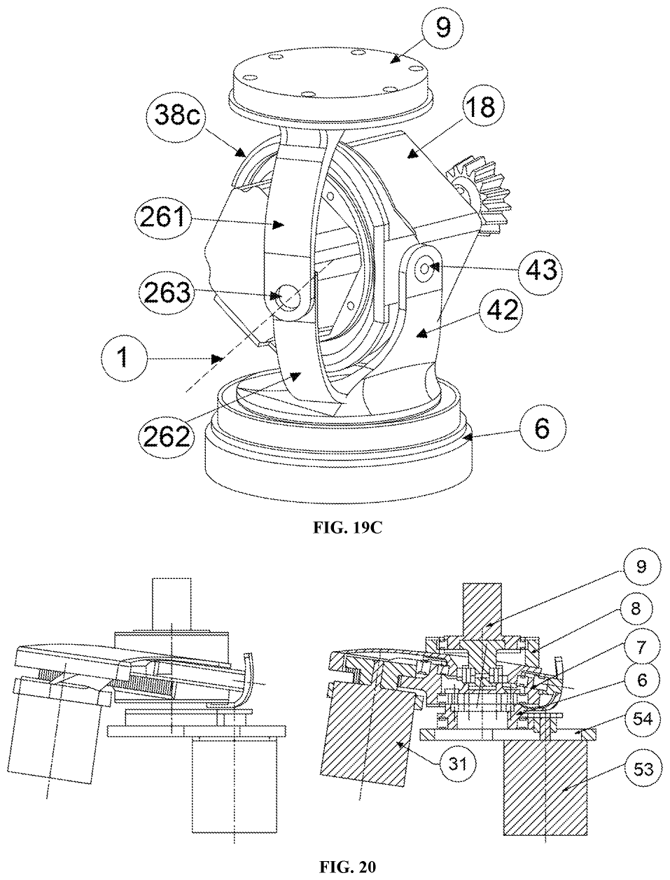

The first arrangement manner of the flexible joint is shown in FIG. 19A. The upper joint 261 of the flexible joint 26 is fixedly connected to the fourth member 9, and the lower joint 262 is fixedly connected with the first member 6, where the articulated shaft 263 of the flexible joint 26 is arranged to be located inside the pitching plane 47 and pass through the surrounding point 39. In this arrangement, the platform rotation axis 1, the axis of the annular bearing 38c and the articulated shaft 263 of the flexible joint 26 are all located in the pitching plane 47 and pass through the surrounding point 39. In the arrangement manner, the platform rotation axis 1 is coaxial with the articulated shaft 263.

The second arrangement manner of the flexible joint is shown in FIG. 19B. The upper joint 261 of the flexible joint 26 is fixedly connected with the fourth member 9, but the lower joint 262 is replaced by the side stand 42. The articulated shaft 263 is replaced by the small bearing 43, where the articulated shaft 263 is coaxial with the axis of the small bearing 43 and vertical to the pitching plane 47. At the same, the articulated shaft 263 passes through the surrounding point 39. In the arrangement, the platform rotation axis 1 is also coaxial with the articulated shaft 263.

The third arrangement manner of the flexible joint is shown in FIG. 19C. The upper joint 261 of the flexible joint 26 is fixedly connected with the fourth member 9, and the lower joint 262 is fixedly connected with the first member 6, where the articulated shaft 263 of the flexible joint 26 is arranged not to be located inside the pitching plane 47 or vertical to the pitching plane 47, but needs to pass through the surrounding point 39 (it is understandable that the flexible joint 26 is arranged at any position of two special positions in FIG. 19A and FIG. 19B). In the arrangement, the platform rotation axis 1 is still coaxial with the articulated shaft 263.

The three arrangement manners of the flexible joints provided in FIG. 19A to FIG. 19C illustrates that in the embodiment, the arrangement position of the flexible joint 26 is not limited, but articulated shaft 263 of the flexible joint 26 should pass through the surrounding point 39 and should remain parallel to the first member. In any arrangement satisfying the conditions, the platform rotation axis 1 is kept also coaxial with the articulated shaft 263.

### [Control System]

In the aforementioned Embodiments 1-2 and 5-11, several embodiments of angle rotation joints having a single degree of freedom are described, respectively. In all of these embodiments, the platform 9B limited by the fourth member 9 only performs single-degree-of-freedom rotation around the fixed platform rotation axis 1. And the rotation of the platform 9B is caused by the rotation of the second member 7 and the third member 8, where the relative rotation angle of the second member 7 and the third member 8 is recorded as a rotation degree Φ, and the included angle between the platform 9B and the horizontal plane caused by the rotation around the platform rotation axis 1 is recorded as the inclination degree g. so that all the single-degree-of-freedom angle rotation joints described in the Embodiments 1-2 and 5-9 satisfy the following relationship:

Φ=sin⁻¹((1−cos(g))/sin(g)·tan(90°−α)), where α is an included angle between both ends of the second member 7 or the third member 8.

Therefore, if the member with an included angle of α at both ends does not rotate (namely, Φ=0°), the platform direction is horizontal (namely, g=0°). If the second member 7 and the third member 8 rotate by 180 degrees relatively (the second member 7 or the third member 8 rotates by 90 degrees relative to the stationary first member 6), the platform reaches the maximum tilt direction, namely, g=2*α. Any tilt direction of the platform between 0° and 2*α can be achieved by partial rotation of the second member 7 and the third member 8 between 0° and 90° according to the aforementioned equation (meaning that the angle range of rotation relative to a stationary first section is between 0° and 90°). Therefore, harmonic oscillation of the platform inclination degree g between 0° and 2*α can be achieved by the constant angular velocity of the counter-rotating second member 7 and the third member 8. After the relative rotation of the second member 7 and the third member 8 reaches 180°, the harmonic oscillation of the platform inclination degree between 0° and 2*α can also be realized by reverse rotation. In the method, a sensor is required to detect 180° rotation, and a control system is used for reverse rotation of the motor. The advantage of the counter-rotating motor is that a smaller gear ring section (a ¼ ring as shown in FIG. 9B) can be used and the cost and equipment weight can be reduced.

According to the aforementioned equation, the same platform inclination degree g can be obtained using a smaller rotation Φ by increasing a. The advantage is that a smaller gear system can be used, but the disadvantage is that the motor needs to provide higher torque.

### Embodiment 12

The aforementioned Embodiments 1-2 provide a single-degree-of-freedom scheme in which a motor and a driving wheel assembly are arranged inside the angle rotation joint. The Embodiments 3-4 provide multi-degree-of-freedom improvement based on the scheme of the Embodiment 1 or Embodiment 2. In the embodiment, a multi-degree-of-freedom improvement based on the single-degree-of-freedom scheme provided in the Embodiments 5-9 is provided.

Referring to FIG. 20, the embodiment first provides a two-degree-of-freedom improvement scheme. A second lower motor 53 is added to the first member 6 of the single-degree-of-freedom angle rotation joint described in the Embodiments 5-11, so that the first member 6 is driven to rotate. The rotation of the first member 6 can change the direction of the platform rotation axis 1, so a two-degree-of-freedom motion system is formed.

The embodiment also provides another two-degree-of-freedom improvement scheme. A second top motor 56 is added to the fourth member 9 of the single-degree-of-freedom angle rotation joint described in the Embodiments 5-11, so that the fourth member 9 is driven to rotate. At the same time, the flexible joint 26 between the fourth member 9 and the first member 6 is cancelled, so that the second top motor 56 can change the direction of the platform rotation axis 1 by rotating the fourth member 9, and the angle rotation joint has two degrees of freedom. On the other hand, as described in the Embodiment 4, by properly controlling the rotary direction and the rotary speed of the second top motor 28, reverse compensating rotation can be provided for the fourth member 9 to substitute the function of the flexible joint 26.

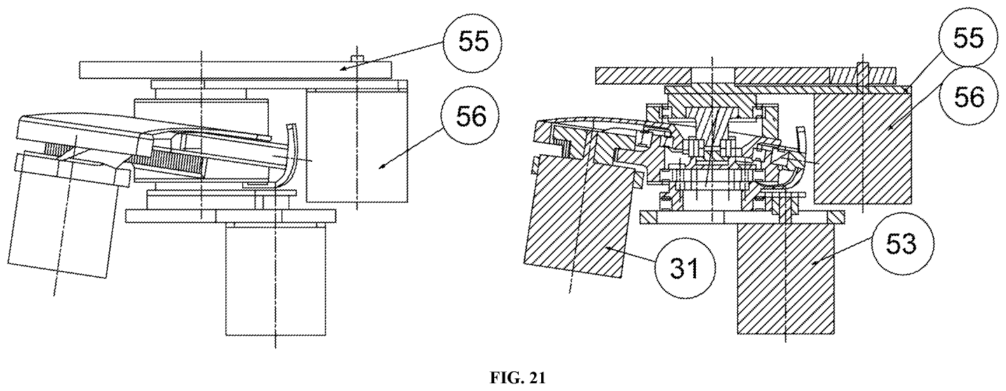

Referring to FIG. 21, the embodiment also provides a scheme that a three-degree-of-freedom motion system is formed through further improvement based on the two-degree-of-freedom motion system as shown in FIG. 20. Specifically, the second top motor 56 is added to the fourth member 9 of the two-degree-of-freedom motion system as shown in FIG. 20. The second top motor 56 is used for driving the fourth member 9 or the rotation platform 55 limited by the fourth member 9 to rotate, so that one degree of freedom is added to the two-degree-of-freedom motion system as shown in FIG. 20 to construct a three-degree-of-freedom motion system.

The embodiment also provides a scheme that a plurality of (such as two, three or more) angle rotation joints having a single degree of freedom are stacked on each other to obtain a motion system having multiple degrees of freedom.

The multi-degree-of-freedom improvement scheme of the single-degree-of-freedom angle rotation joint in the embodiment is similar to the improvement scheme provided in the Embodiments 3-4. The main difference lies in that the improvement basis of the Embodiments 3-4 is the single-degree-of-freedom angle rotation joint inside which the motor is arranged, but the improvement basis of this embodiment is the single-degree-of-freedom angle rotation joint outside which the motor is arranged.

### Embodiment 13

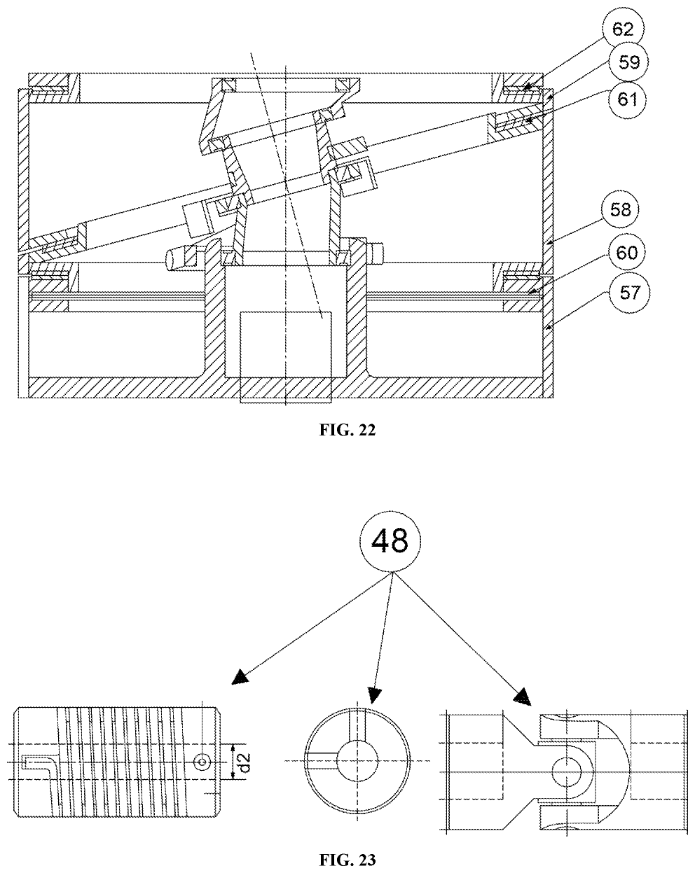

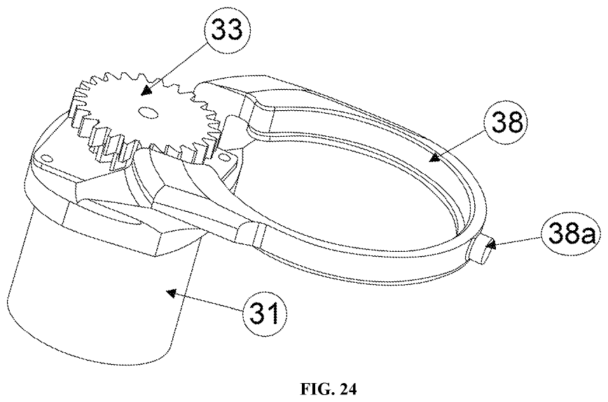

In some special application scenarios, the motion system may be polluted (such as dust and rain) or the motion system needs to bear large load, and excessive load may cause damage to the motion system. In order to enable the motion system of the present disclosure (including a single-degree-of-freedom angle rotation joint and a multi-degree-of-freedom improvement scheme based on the single-degree-of-freedom angle rotation joint) to still maintain good motion performance in these special application scenarios, exoskeletons may be used to surround the motor system. An embodiment of a motion system surrounded by the exoskeletons is shown in FIG. 22, where the first member 6, the second member 7, the third member 8 and the fourth member 9 constituting the motion system are the cores of the system, and exoskeleton segments connected to the corresponding members are arranged around the above-mentioned members, so that rotation of the members can cause the same rotation of the exoskeleton segments, such as a first segment 57 fixedly connected with the first member 6, a second segment 58 fixedly connected with the second member 7, a third segment 59 fixedly connected with the third member 8, a fourth segment (not shown in figures) connected with the fourth member 9. The exoskeleton segments have the same angle as the members connected with the exoskeleton segments, and are stacked on each other in the same manner as respective members. For example, the first segment 57 as a basis of the exoskeletons is located at the bottom, and the second segment 57 is slidaly placed on the top of the first segment 57. The second segment 57 is provided with two ends with an included angle α, and a top slope of the second segment 57 is arranged to be parallel to a top slope of the second member 7. The third segment 58 is also provided with two ends with an included angle α, and a bottom slope of the third segment 58 is arranged to be parallel to a bottom slope of the third member 8. The third segment 58 is slidably placed on the top of the second segment 57. The sliding fit between the respective segments of the exoskeletons can be achieved by means of exoskeleton bearings 60, 61, 62 or dry film lubricating materials such as polytetrafluoroethylene. The sliding fit between the respective segments of the exoskeletons can transfer load between adjacent exoskeleton segments, but cannot transfer torque. Therefore, the exoskeletons can share axial load without affecting the platform angle, and can also provide shielding protection for the angle rotation joint as the system core.
Embodiment 14

The embodiment provides an application example of the motion system shown in the aforementioned embodiments.

The motion system can be used for a target tracker.

Specifically, the motion system may be used for a solar tracker of a solar panel. Equipment supported by the platform always faces the sun through the rotation of the platform around the platform rotation axis. In this application, the running speed of the motor is much greater than the angular change speed of the sun. Therefore, it is necessary to configure a gear box for deceleration in the motion system, and an eccentric gear box with an extremely high transmission ratio may be selected. The eccentric gear box is preferably integrated inside the motor.

Or, the motion system can be used for a satellite tracker. Equipment supported by the platform always faces a target satellite through the rotation of the platform around the platform rotation axis.

The allowed system may be used for healthcare equipment.

Specifically, the motion system also can be used for an office seat, and the muscles of the lower back of a sedentary person are exercised by adjusting the seat board posture of the office seat.

Or, the motion system is used for a rehabilitation seat, and degraded muscles are exercised and the muscles are promoted to recover functions by adjusting the posture of the rehabilitation seat to drive a patient lack of muscle functions caused by aging degeneration, muscle injury, postoperative rehabilitation and other reasons to move.

Or, the motion system is used for a child seat, and a child can be promoted to keep a correct sitting posture by changing the posture of the seat.

Or, the motion system is used for a sickbed, and a patient is assisted to be turned over by rotating the sickbed around the platform rotation axis.

Or, the motion system is used for an X-ray machine, and X-ray scanning is realized by rotating the X-ray machine around the platform rotation axis.

Or, the motion system is used for a baby seat, and the posture of the seat can be rapidly adjusted according to the signal of an automobile driving state fed back by an inertial sensor, so as to reduce the impact effects of rapid braking, sharp bending or even collision accidents on a baby.

The motion system can be used for entertainment equipment.

Specifically, the motion system is used for a virtual reality seat, and the posture of the seat can be rapidly adjusted to simulate the virtual environment in the reality in cooperation with the contents of virtual videos according to program commands.

Or, the motion system is used for display equipment, and the directions of television screens, computer screens, etc., can be adjusted according to signals fed back by a human tracking sensor, so as to directly face a human body all the time.

The motion system can be used for optical equipment.

Specifically, the motion system is used for a camera, and a target object can be captured according to sensing equipment such as an infrared sensor and an acoustic wave sensor, and the camera rotates according to a sensing signal, so as to directly face the object and take photos or videos.

Or, the motion system is used for lighting equipment, and the direction of the lighting equipment such as lamps can be adjusted according to set programs, so as to create a stage atmosphere.

The allowed system is also used for a CNC (Computer Numerical Control) system, and the platform rotates according to commands, so that the posture of a workpiece or a cutter mounted on the platform is adjusted.

The specific application of the motion system described above is realized by means of a control system for controlling the rotary speed and the rotary direction of the motor.

The above is only examples of preferred embodiments of the present disclosure, and should not be construed as limitation of all possible embodiments of the present disclosure. The actual scope of protection of the present disclosure is defined by the claims.

What is claimed:

1. A single-degree-of-freedom angle rotation joint, comprising four members which are stacked on each other, wherein the four members comprise:
a first member, which is used as a basis and does not rotate, wherein the first member is located at a lowest part;
a second member, slidably arranged at a top of the first member, wherein the second member is provided with two non-parallel ends;
a third member, slidably arranged at a top of the second member, wherein the third member is provided with two non-parallel ends; and
a fourth member, slidably arranged at a top of the third member, wherein the fourth member is used as a platform, or the fourth member is used for limiting the platform, and the platform only performs single-degree-of-freedom rotation around a fixed platform rotation axis;
wherein the second member and the third member have a same included angle α at both ends, and are driven by a single motor to rotate respectively in directions opposite to each other at an equal angular velocity, and the fourth member does not rotate along with the third member.

2. The single-degree-of-freedom angle rotation joint according to claim 1, wherein the fourth member is connected to the first member by means of a flexible joint with a single rotation axis to restrain a rotation along with the third member; and a rotation axis of the flexible joint is parallel to the platform rotation axis.

3. The single-degree-of-freedom angle rotation joint according to claim 2, wherein the motor distributes power to the second member and the third member through a transmission assembly.

4. The single-degree-of-freedom angle rotation joint according to claim 3, wherein the motor and the transmission assembly are located inside the angle rotation joint.

5. The single-degree-of-freedom angle rotation joint according to claim 4, wherein the motor is fixedly connected with the second member.

6. The single-degree-of-freedom angle rotation joint according to claim 5, wherein the transmission assembly comprises a driving wheel set formed by connecting two conical driving wheels in series, and the motor outputs shaft power to the driving wheel set; and the transmission assembly further comprises: an inner driving ring fixed on the first member, an outer driving ring coaxial with the inner driving ring and slidably arranged on the first member, and a second outer driving ring fixed at a bottom of the third member and partially meshed with the outer driving ring; wherein the outer driving ring and the second outer driving ring have a same diameter and an included angle of α.

7. The single-degree-of-freedom angle rotation joint according to claim 6, wherein the driving wheel set comprises a small driving wheel meshed with the inner driving ring and a large driving wheel meshed with the outer driving ring.

8. The single-degree-of-freedom angle rotation joint according to claim 7, wherein the driving wheels and the driving rings satisfy a following relationship:
Rₘₑₐₙ₂₂/Rₘₑₐₙ₂₁=(r₂₂−r₂₁)/r₂₁;
where Rₘₑₐₙ₂₂ is a mean radius of the outer driving ring, Rₘₑₐₙ₂₁ is a mean radius of the inner driving ring, r₂₂ is a mean radius of the large driving wheel, and r₂₁ is a mean radius of the small driving wheel.

9. The single-degree-of-freedom angle rotation joint according to claim 8, wherein r₂₁/r₂₂ is 1:2.

10. The single-degree-of-freedom angle rotation joint according to claim 1, wherein the platform performs single-degree-of-freedom rotation around the fixed platform rotation axis, and the rotation causes a maximum inclination angle of the platform relative to a horizontal plane to be 2α.

11. The single-degree-of-freedom angle rotation joint according to claim 4, wherein the motor is fixed on the third member, and the inner driving ring and the outer driving ring are fixed and slidably supported on a lower surface of the fourth member, and the second outer driving ring is fixed at the top of the second member, and the driving wheel set is meshed with the inner driving ring and the outer driving ring connected to the fourth member.

12. The single-degree-of-freedom angle rotation joint according to claim 3, wherein the motor and the transmission assembly are located outside the angle rotation joint.

13. The single-degree-of-freedom angle rotation joint according to claim 12, wherein the motor is unfixedly mounted through a mounting base, but the motor is limited so that a motor axis is always parallel to a second rotation axis around which the third member rotates.

14. The single-degree-of-freedom angle rotation joint according to claim 13, wherein the mounting base comprises a mounting part for fixing the motor and a sliding part for being in sliding fit with the top of the second member or the bottom of the third member, the mounting base is located on a mounting surface passing through a surrounding point, and an intersection of the motor axis and the mounting surface is a mounting point A, the mounting point A follows a longitude line on a spherical surface with the surrounding point as a center of sphere.

15. The single-degree-of-freedom angle rotation joint according to claim 14, wherein the motor or the mounting base is connected to a stationary member to perform limitation on the motor, and the motor is prevented from rotating around a first rotation axis.

16. The single-degree-of-freedom angle rotation joint according to claim 15, wherein a compliant coupling is connected to the mounting base and the first member.

17. The single-degree-of-freedom angle rotation joint according to claim 16, wherein one end of the compliant coupling is connected with the first member, and an other end of the compliant coupling extends to the surrounding point; and the mounting base further comprises a connecting part extending to the surrounding point for being connected with the compliant coupling.

18. The single-degree-of-freedom angle rotation joint according to claim 15, wherein a guide pin mechanism is connected to the mounting base and the first member.

19. A multi-degree-of-freedom motion system, comprising the single-degree-of-freedom angle rotation joint according to claim 1, wherein the multi-degree-of-freedom motion system comprises at least two single-degree-of-freedom angle rotation joints which are stacked on each other.

20. A motion system with exoskeletons, comprising the angle rotation joint according to claim 1, wherein around members constituting the angle rotation joint or the motion system, exoskeleton segments connected with corresponding members are arranged, so that rotation of the members leads to a same rotation of the exoskeleton segments.
